(19) United States
(12) Patent Application Publication
(10) Pub. No.: US 2025/0104554 A1
(43) Pub. Date: Mar. 27, 2025

(54) TRAFFIC CONTROL SYSTEM

(71) Applicant: Lightracor, Inc., Santa Monica, CA (US)

(72) Inventor: Zac Wood, Santa Monica, CA (US)

(73) Assignee: Lightracor, Inc., Santa Monica, CA (US)

(21) Appl. No.: 18/566,916

(22) PCT Filed: Jun. 6, 2022
(86) PCT No.: PCT/US2022/032390

§ 371 Date: Dec. 4, 2023

(51) Int. Cl. G08G 1/01; B60W 60/00

(52) U.S. Cl. CPC G08G 1/0145; B60W 60/0025; G08G 1/0116

(57) ABSTRACT

A traffic control system has a roadway, a computerized processing center scraping data from on-line traffic monitoring and reporting sites, and a plurality of traffic control vehicles. The computerized processing center determines an increasing likelihood of gridlock at a specific location on the roadway, determines a speed and duration of traffic control to be applied at a second location with traffic approaching the first location, the speed and duration calculated to reduce the likelihood of congestion at the first location, and deploys individual ones of the plurality of traffic control vehicles to the second location and controls the individual ones of the traffic control vehicles to impede traffic at the second location to the determined speed for the determined duration.

### CROSS-REFERENCE TO RELATED DOCUMENTS

The present invention is a National Entry from PCT/US2022/032390, filed Jun. 6, 2022

### BACKGROUND OF THE INVENTION

### 1. Field of the Invention

The present invention is in the technical area of traffic control and pertains more particularly to a hardware and software system to impede traffic flow at critical points.

### 2. Description of Related Art

Traffic congestion is a well-known phenomenon that causes a great deal of difficulty for many people and wastes a great deal of money. Typical remedies include speed limits typically indicated by roadside signs, radio programs and Internet sites that track and report accidents and regions of congestion to enable drivers to plan their travel and avoid congested points.

To the inventor's knowledge conventional solutions are mostly just advisory, such as speed limit signs, and do not provide any proactive means of altering traffic flow in a way that might avoid or resolve congestion.

What is needed is a system that determines in real time where traffic congestion is occurring or may occur, exactly where on a particular roadway impeding traffic flow may alleviate the probability of a traffic jam and has specially enhanced vehicles or other means of impeding traffic flow.

### BRIEF SUMMARY OF THE INVENTION

In an embodiment of the invention a traffic control system is provided, comprising a roadway, a computerized processing center scraping data from on-line traffic monitoring and reporting sites, and a plurality of traffic control vehicles. The computerized processing center determines an increasing likelihood of gridlock at a specific location on the roadway, determines a speed and duration of traffic control to be applied at a second location with traffic approaching the first location, the speed and duration calculated to reduce the likelihood of congestion at the first location, and deploys individual ones of the plurality of traffic control vehicles to the second location and controls the individual ones of the traffic control vehicles to impede traffic at the second location to the determined speed for the determined duration.

In one embodiment the system further comprises sensing apparatus monitoring traffic conditions on the roadway, wherein the computerized processing center receives data from the sensing apparatus and utilizes that data in determining likelihood of congestion. Also, in one embodiment the on-line traffic monitoring and reporting sites comprise one or more of Google Maps™, Waze™, Mapquest™. In one embodiment the computerized processing center builds models comprising characteristics of one or more of morning and evening congestion, frequent traffic accident areas, choke points and bottlenecks, emergency vehicle calls, road construction, lane maintenance routes and times and special and frequent events around large venues like stadiums, specific to a set of roadways. And in one embodiment authorized knowledge workers access interactive interfaces presented by the computerized processing center, and through links and input fields in the interfaces specify specific roadways to be controlled, and for which data may be retrieved, processed, and utilized, constraining functionality to the specific roadways.

In one embodiment of the system the computerized processing center, utilizing algorithms especially developed for the purpose, builds a running circumstantial map of bottlenecks and potential bottlenecks on the specific roadway. Also, in one embodiment the plurality of traffic control vehicles comprises automatically controlled vehicles deployed from stations along the roadway, the stations having computerized apparatus for receiving instructions from the computerized processing center and wireless communication apparatus adapted to deploy and control the plurality of traffic control vehicles in maneuvers to impede traffic flow. Also, in one embodiment the plurality of traffic control vehicles comprises vehicles driven by agents of the system, the agents each having a smartphone executing a mobile app whereby the computerized processing center instructs the agents via the mobile app in maneuvering to impede traffic in traffic control operations. In one embodiment the individual ones of the traffic control vehicles are caused to maneuver at the second location in a manner to block following traffic for the determined duration from exceeding the determined speed. And in one embodiment, at the end of the determined duration, the computerized processing center manages the deployed traffic control vehicles to disperse.

In another aspect of the invention a traffic control method is provided, comprising determining an increasing likelihood of gridlock at a specific location on a controlled roadway by a computerized processing center scraping data from on-line traffic monitoring and reporting sites, determining a speed and duration of traffic control to be applied at a second location with traffic approaching the first location, the speed and duration calculated to reduce the likelihood of congestion at the first location, and deploying individual ones of a plurality of traffic control vehicles to the second location and controlling the individual ones of the traffic control vehicles to block traffic at the second location to the calculated speed for the calculated duration.

In one embodiment the method further comprises sensing apparatus monitoring traffic conditions on the roadway, comprising the computerized processing center receiving data from the sensing apparatus and utilizing that data in determining likelihood of congestion. In one embodiment the method comprises scraping data from on-line traffic monitoring and reporting sites comprising one or more of Google Maps™, Waze™, Mapquest™. In one embodiment the method comprises the computerized processing center building models of one or more of morning and evening congestion, frequent traffic accident areas, choke points and bottlenecks, emergency vehicle calls, road construction, lane maintenance routes and times and special and frequent events around large venues like stadiums, specific to a set of roadways. And in one embodiment the method comprises authorized knowledge workers accessing interactive interfaces presented by the computerized processing center, and through links and input fields in the interfaces specifying specific roadways to be controlled, and for which data may be retrieved, processed, and utilized, constraining functionality to the specific roadways.

In one embodiment the method comprises the computerized processing center, utilizing algorithms especially developed for the purpose, building a running circumstantial map of bottlenecks and potential bottlenecks on the specific roadway. In one embodiment of the method the plurality of traffic control vehicles comprises automatically controlled vehicles deployed from stations along the roadway, the stations having computerized apparatus for receiving instructions from the computerized processing center and wireless communication apparatus adapted to deploy and control the plurality of traffic control vehicles in maneuvers to impede traffic flow, comprising the computerized processing center deploying individual ones of the automatically controlled traffic control vehicles.

In one embodiment of the method the plurality of traffic control vehicles comprises vehicles driven by agents of the system, the agents each having a smartphone executing a mobile app whereby the computerized processing center instructs the agents via the mobile app in maneuvering to impede traffic in traffic control operations, comprising the computerized processing center deploying individual ones of the vehicles driven by agents of the system. In one embodiment the method comprises controlling the individual ones of the traffic control vehicles to maneuver at the second location in a manner to block following traffic for the determined duration from exceeding the determined speed. And in one embodiment the method comprises, at the end of the determined duration, the computerized processing center managing the deployed traffic control vehicles to disperse

### BRIEF DESCRIPTION OF THE SEVERAL VIEWS OF THE DRAWINGS

FIG. 1 is an architecture diagram of a computerized processing center according to an embodiment of the invention.

FIG. 2 is a diagram of a roadway network in an embodiment of the invention.

FIG. 3A is a side elevation view of a traffic management vehicle in an embodiment of the invention.

FIG. 3B is a top plan view of the traffic management vehicle of FIG. 3A in an embodiment of the invention.

FIG. 4A is a plan view of a vehicle deployment station in an embodiment of the invention.

FIG. 4B illustrates a traffic control vehicle in a stage of deployment.

FIG. 4C is a diagram illustrating blocking of traffic.

FIG. 5 is a flow diagram depicting a process in an example of the invention.

### DETAILED DESCRIPTION OF THE INVENTION

For the purposes of this specification a traffic jam, or gridlock is defined as when vehicles on a roadway are fully stopped for at least a short period of time. Typically, in a gridlock by this definition, vehicles may be stopped or nearly so for a short period, and then may be able to move slowly forward to be stopped again after another short period of time. As population increases over time more and more vehicles are on the roadways and the frequency of traffic jams also increases. It is well known also that traffic is more dense in urban centers and industrial areas, and such circumstances also increase probability of traffic jams. Probability of traffic congestion is also dependent on time of day, such as “rush hour” periods.

As of the time of filing this patent application an urban commuter is stuck in traffic for about 39 hours every year, the average yearly cost to each diver is about $803.00. Other circumstances that contribute to frequency and severity of traffic jams are traffic accidents, bad weather, work zones and poor traffic signal timing.

The present inventors have developed a system, which is a system with both hardware and software components. Proprietary software is AI-based and is adapted to scrape time sensitive data from Google Maps™, Waze™, Mapquest™ and other traffic analyzing websites and government dispatch systems. The program builds models of morning and evening congestion, frequent traffic accident areas, choke points and bottlenecks, emergency vehicle calls, road construction, lane maintenance routes and times and special and frequent events around large venues like stadiums.

The system software, utilizing algorithms especially developed for the purpose, builds a running circumstantial map of bottlenecks and potential bottlenecks on one or more roadways for which data and real time information is available. The system software executes on a central server which is directly connected to the well-known Internet Network.

The inventors believe that if all vehicles were programmed and controlled to operate at one speed, all adhering to that speed, that traffic jams would be largely eliminated. It is primarily the tendency of a significant percentage of drivers to exceed speed limits and other drivers to be “road boulders’ by driving too slow, that causes regions of congestion on a roadway.

In one embodiment of the present invention a roadway or a set of roadways that are served by operation of the system of the invention are provided with physical apparatus adapted to directly influence traffic flow at any one or more of a plurality of locations along the roadway or roadways that are associated with the system of the invention. The software communicates with the physical apparatus at the locations along the roadway or roadways to initiate actions to control the flow of traffic.

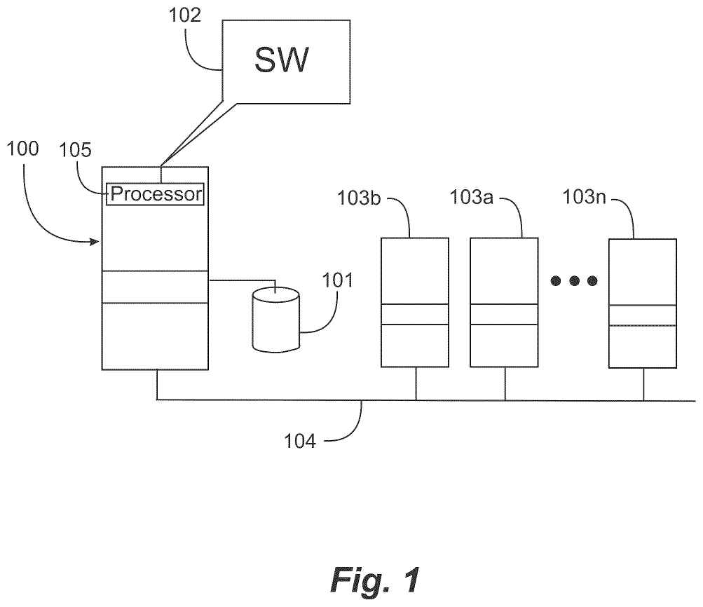

FIG. 1 is an architecture diagram illustrating logic and control components of a computerized processing center in one embodiment of the invention. A server 100 coupled to a data repository 101 is connected to the well-known Internet network represented by Internet backbone 104, which is meant to include all networks and sub networks that make up the Internet. A processor 105 in server 100 executes software 102.

Software 102 is adapted to scrape data and real-time information from Internet connected sites 103a, 103b and others through 103n. There is no limit to the number of sources that may be accessed and used by server 100. As described above, these sources may include at least Google Maps™, Waze™, Mapquest™ and many other traffic analyzing websites and government dispatch systems.

Software 102 executed by processor 105 scrapes relevant data from this group of websites, receives data from sensors deployed along a controlled roadway, and builds models of morning and evening congestion, frequent traffic accident areas, choke points and bottlenecks, emergency vehicle calls, road construction, lane maintenance routes and times and special and frequent events around large venues like stadiums, specific to a set of roadways.

In one embodiment of the invention authorized knowledge workers may access interactive interfaces programmed into software 102 and stored in data repository 101, and through links and input fields in such interfaces specify specific highways and roadways to be controlled, and for which data may be retrieved, processed, and utilized. The functionality of the invention in various embodiments is constrained to a specific set of roadways that are enhanced with hardware innovations described below, which hardware may be initiated and deployed to perform traffic control processes according to the invention.

The system software, utilizing algorithms especially developed for the purpose, builds a running circumstantial map of bottlenecks and potential bottlenecks on a roadway or a set of roadways which have been identified as an equipped roadway or set of roadways for which data and real time information is available.

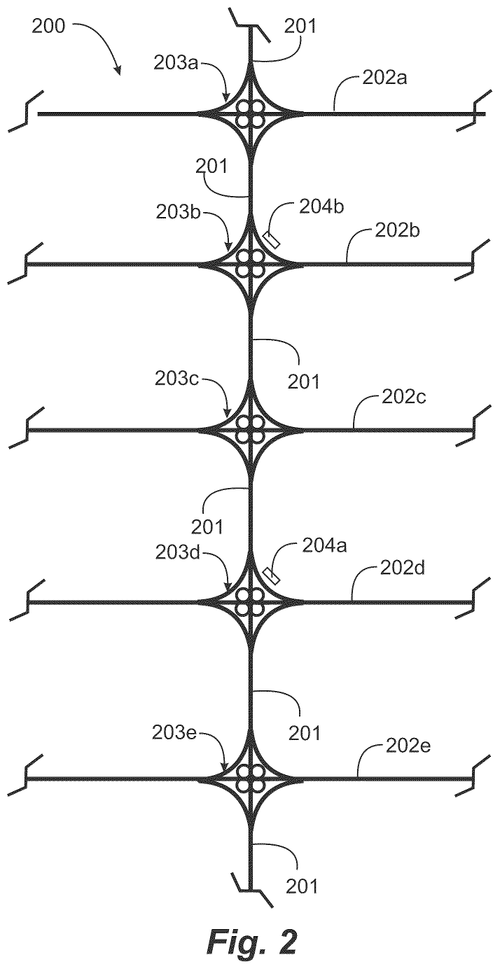

FIG. 2 is an example of a relatively simple set of roadways that may be equipped with hardware according to an embodiment of the invention, and that may be controlled for traffic flow on a real-time basis according to an embodiment of the present invention. FIG. 2 depicts a North-South freeway 201 intersecting with a series of five crossroads 202a through 202e by a series of five clover-leaf interchanges 203a through 203e. All of the roads are shown with broken symbols to limit the roadway system. A purpose in this example is to control traffic on North-South highway 201 between the broken symbols. The skilled person will understand that this is just one of many possible examples, and the set of roadways could be very different in other examples. The inventor believes this one example may be sufficient to describe the invention.

A variety of sensing and monitoring apparatus is deployed along the roadway that is to be controlled. This apparatus may comprise daytime/nighttime (visibility), cameras that collect car counts relative to time duration. Speed and time of count may be used to predict or determine whether an area will be contributing to gridlock to another area upstream. Time of day for typical amount of congestion, commute times, the existence of a game at a nearby stadium and so forth may be built into models and algorithms game at stadium nearby, etc. The monitoring process is a continuing dynamic process with evolving conditions. The system, through SW 102, updates models on a periodic basis, and predicts and identifies areas where gridlock may soon occur. This information is relayed to drivers of traffic control vehicles with instructions, developed by other algorithms, of nature of blockage to alleviate the gridlock conditions expected. The instructions may comprise determining timing of obstruction and location, how may miles out to begin obstruction, and how long to obstruct. Determining speed to slow down to during obstruction is critical to avoid creating rather than alleviating gridlock. For example, 40 or 45 mph slowdown may prevent upstream gridlock while not creating new gridlock. The goal always being to slow down as little as possible in relation to speed limit.

In one embodiment traffic control vehicle 301 may comprise a cabin and physical controls whereby an agent may drive the vehicle like an ordinary vehicle. In this embodiment an agent may have a mobile app executing on the agent's smart phone, and the agent driving the control vehicle may be instructed via the app from a control station to obstruct traffic via zig zag movement of one car, or one traffic control vehicle per lane, in alignment, across lanes, so normal traffic cars cannot bypass. In this embodiment drivers may be instructed to begin obstructing based on GPS location ID or may be sent markers via the app to obstruct, to stop obstructing or to provide a period of time to commence and continue obstructing.

In embodiments employing agents driving traffic control vehicles the agents and vehicles may be deployed at locations such as deployment stations like station 204a or 204b, but in many such embodiments a plurality of agents in marked traffic control vehicles may be cruising particular stretches of road for which those agents are responsible in an overall system. An agent or a group of agents may cruise one stretch in one direction, then take an off ramp and an on ramp back onto the same roadway but the opposite direction and repeat this process for a period of time during which instructions may or may not come for obstruction.

In embodiments of the invention Highway Patrol is notified and can identify traffic control vehicles, which have lights and markings by which they may be clearly identified. The traffic control vehicles have cameras and built-in reporting of time and mpg associated with camera images, so they can capture images and ticket vehicles that attempt to speed or to bypass the traffic control vehicles. There may be automatic ticket generation like at stop lights. Cameras of all vehicles may also collect passive data used in AI modeling such as average mpg for time of day.

In another embodiment, as shown in FIG. 2 there may be vehicle deployment stations implemented in the roadway system, each positioned on an onramp of the cloverleaf leading on to roadway 201. Deployment stations 204a and 204b are shown as an example. These two stations are meant to be illustrative of these and other stations where traffic control vehicles may be positioned to be deployed to control traffic as needed, determined by system software 102, utilizing algorithms especially developed for the purpose. Software 102, as described above, builds a running circumstantial map of bottlenecks and potential bottlenecks on a roadway or a set of roadways which have been identified as an equipped roadway or set of roadways for which data and real time information is available. In this case the set of roadways is that set shown in FIG. 2.

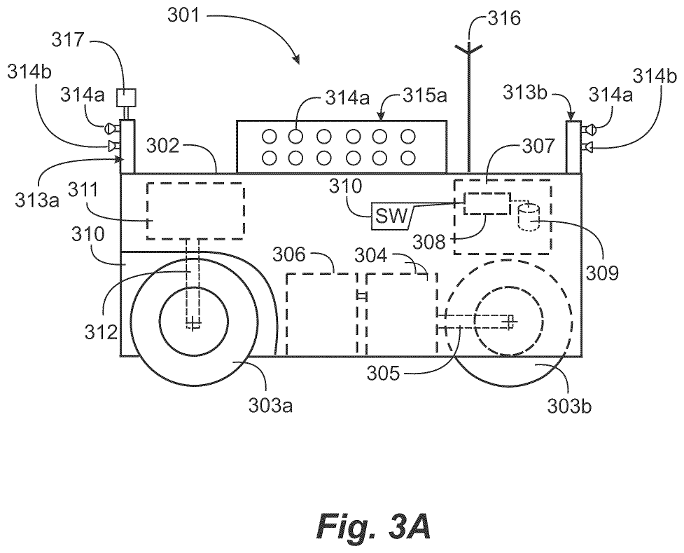

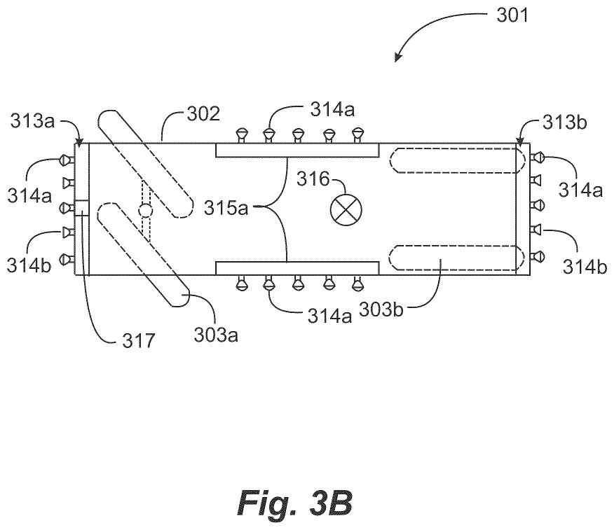

FIGS. 3A, and 3B are illustrations of an automated traffic control vehicle 301 in an embodiment of the invention. FIG. 3A is a side elevation view of the vehicle with a body 302, front and back wheel pairs 303a and 303b, and an electric motor 304 interfaced to at least wheel pair 303b by transmission equipment 305. Motor 304 in this example is powered by a battery 306 of a sort typically used by electric vehicles. A steering mechanism 311 is coupled to front wheels 303a by linkages 312.

Vehicle 301 comprises a computerized unit 307 having a processor 308 and a digital storage unit 309. Processor 308 executes software 310. An antenna 316 facilitates communication with computerized circuitry at stations such as stations 204a and 204b via two-way circuitry as part of unit 307. A front mount board 313a and a back mount board 313b mount lights 314a and at last one loudspeaker 314b. Lights 314a may also be presented on side boards 315a.

The number, types and color of lights 314a may vary in different embodiments and may be controlled by computer code executed by processor 308 to turn on and off and to flash with different periodicity. Lights may also be manually controlled by an agent from a remote location that may have access to real time imagery through an image apparatus 317. Imaging apparatus 317 may be capable of both still and video imaging. Apparatus 317 may be remotely controlled by an agent to rotate to view in different directions and may transmit imagery captured to be recorded in repository 309 and may transmit imagery to a remote station where an agent may view the imagery on a display screen.

FIG. 3B is a top plan view of vehicle 301 with front wheel pair 303a turned to one side to cause the vehicle to turn in a relatively tight arc. Turning radius and process may be controlled in some circumstances by execution of computer code by processor 308, as is described more fully below, and in some instances may be controlled by a remote agent, discussed briefly above, through input mechanisms at a remote station, where the agent may view real time imagery from image apparatus 317. Mount boards 313a, 313b and 315a are shown along with mounted lights and speakers. Internal elements such as the motor and battery, and the computerized equipment is not shown in FIG. 3B.

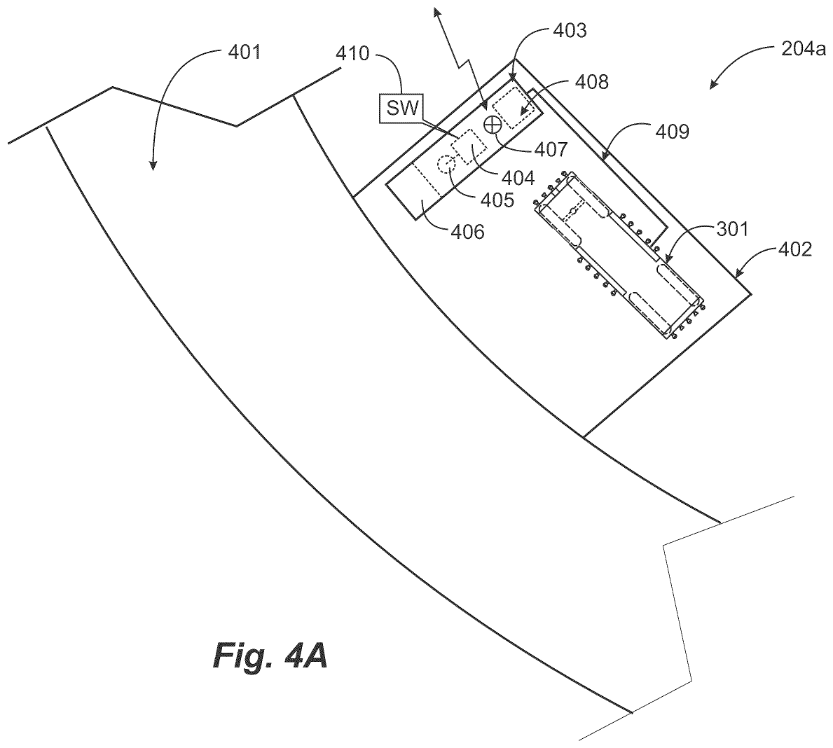

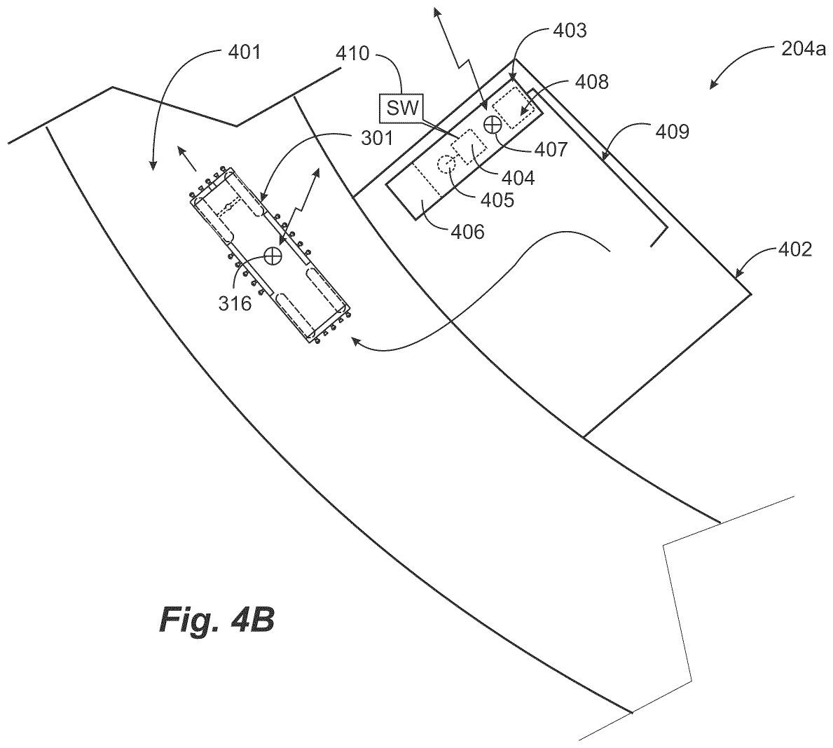

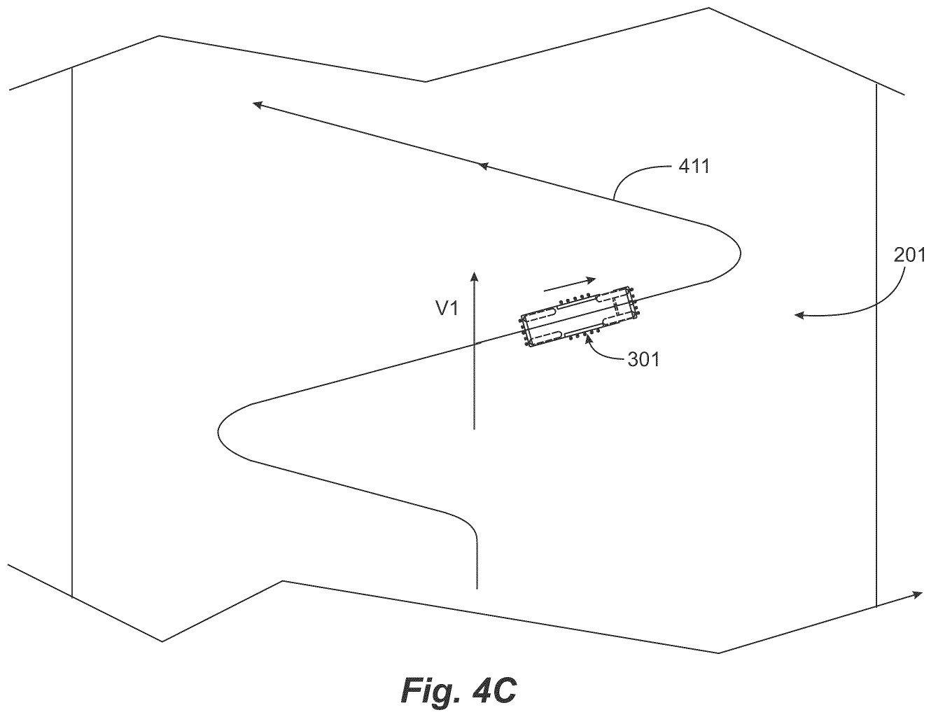

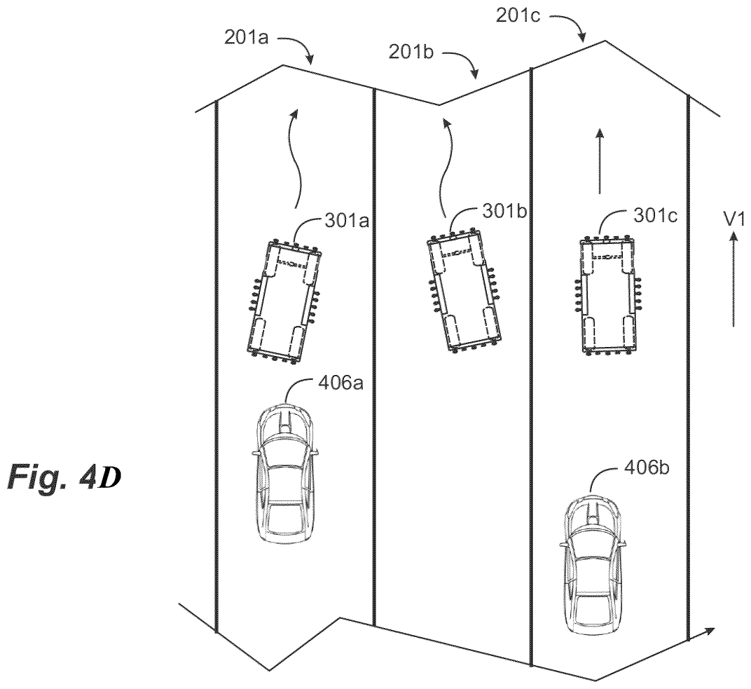

Referring back to FIG. 2, as described above two vehicle deployment stations 204a and 204b are illustrated as located in respective onramps of roadway 201. FIG. 4A is an enlarged view of station 204a, which may be identical to station 204b. A relatively small portion of onramp 401 in cloverleaf 203d onto highway 201 from side road 202d is shown. Alongside the portion of the onramp shown, an area 402 is illustrated as area for deployment station 204a. One traffic control vehicle 301 (see FIGS. 3A and 3B) is seen from above parked in area 402.

In one embodiment area 402 may be walled or fenced around the three sides that do not border the onramp. Also, in one embodiment there may be a control cabinet 403 housing a server with a processor 404 coupled to a data repository 405, as well as other components. Processor 404 may execute software 410. The computerized apparatus also comprises a two-way wireless transceiver 407 with an antenna that may establish connection to remote computerized stations and to the Internet network. In one embodiment transceiver 407 couples to Internet connected server 100 with processor 105 executing software 102 (see FIG. 1).

Control cabinet 403 additionally comprises a battery charging apparatus 408 that connects by a cable 409 to vehicle 301 when the vehicle is resident in station 204a, and may disconnect either manually or automatically when the vehicle is deployed at need. It was described above with reference to FIG. 1 that Software 102 is adapted to scrape data and real-time information from Internet connected sites, and builds models of morning and evening congestion, frequent traffic accident areas, choke points and bottlenecks, emergency vehicle calls, road construction, lane maintenance routes and times and special and frequent events around large venues like stadiums, all specific to a set of roadways. To better explain the system of the invention it assumed here that the system intelligence is operating to provide information specific to the set of roadways depicted in FIG. 2 and described above with reference to FIG. 2. This may occur in parallel with provision of information specific to many other sets of roadways.

At one point in time, it may be determined by execution of Software 102 that congestion along highway 201 between cloverleaf 203c and 203b in the Northbound (upward in the figure) lanes is approaching a critical situation, and that action is required to delay traffic approaching that region from the South. It should be noted that FIG. 2 is representative, and that the portion of highway 201 between cloverleaf 203c and 203b may be lengthy, such as miles, and that there may also be curvature of the roadway along that portion.

Algorithms executed in Software 102 determine at this point in time to deploy a specific traffic control vehicle 301 at station 204a onto highway 201 in the portion between cloverleaf 203d and 203e, and to control that vehicle to delay traffic travelling North approaching the portion ahead between cloverleaf 203c and 203b, to alleviate the increasing congestion in the portion between cloverleaf 203c and 203b.

FIG. 4B illustrates vehicle 301 having exited area 402 of station 204a and having accelerated onto onramp 401. At this point, and during the deployment of the vehicle until it is returned to station 204a at a later point in time, the vehicle is controlled by software executing on processor 404 of the server in cabinet 403 jointly with software 310 executing on processor 308 in unit 307 in the vehicle itself. Processor 404 in cabinet 403 couples with processor 308 in vehicle 301 via wireless communication circuitry in the cabinet and in the vehicle.

In deployment vehicle 301 utilizes imaging apparatus 317 for several different purposes. Real time imagery is provided to SW 310 which controls steering mechanism 311 to manipulate linkages 312 to turn the vehicle as needed. In some embodiments there may be proximity sensors along edges of the highway that may interact with vehicle 301 and SW 310 to update vehicle position, and in some embodiments there may be painted stripes on the road itself that the vehicle may follow using imaging apparatus 317 in conjunction with SW 310.

From the position illustrated in FIG. 4B vehicle 301 continues on onramp 401 to merge with traffic on highway 201 between cloverleaf 203d and cloverleaf 203c. Imagery from apparatus 317 transmitted to SW 310 is used to control the merging process, varying vehicle speed and attitude as necessary. Once the vehicle is merged with traffic a process is initiated to inform and alert drivers of all vehicles in the vicinity of control vehicle 301. This process may include control of flashing lights on the control vehicle as well as loud announcement of recorded messages via speaker(s) 314b. Drivers of vehicles in the vicinity of the control vehicle will be informed that a slowing process is starting, and that passing the control vehicle may result in arrest warrants to be issued and traffic officers to be alerted to intercept the offending vehicle(s).

Another part of the overall process is that the system is controlled by local and state government and underscored by laws passed and in effect. Citizens, before use of the system of the invention are educated about the existence of the systems, where they are deployed, how they work, and what is expected of the citizens on the road in areas where the system are in use. In this circumstance, the appearance of a traffic control vehicle 301 may be sufficient to bring drivers in the vicinity into compliance with operations of the system. A vehicle that passes the control vehicle may be reported to local and state law enforcement, and in the event that the vehicle is not pulled over and the driver cited, a process will be initiated to report to the Department of Motor Vehicles, in which the drivers driving privileges may be suspended or revoked, and in which the driver's vehicle may be impounded.

After a programmed time period after first appearance of the control vehicle, the control vehicle assumes a position in a middle lane of the highway, and assumes a speed determined to be adequate to prevent further congestion of the roadway up ahead that was determined to be approaching a congestion threshold. The fact that drivers of vehicles in the immediate vicinity know that passing the control vehicle will result in remedial action may be enough to slow the traffic behind the control vehicle.

FIG. 4C illustrates functionality in controlling traffic. in an embodiment of the invention. In FIG. 4C roadway 201 comprises three side-by-side lanes 201a, 201b and 201c. After the initial process of notification, three traffic control vehicles 301a, 301b and 301c are shown proceeding in a horizontal row in the three lanes in a manner that commuter vehicles 406a and 406b cannot pass. The three traffic control vehicles may maneuver somewhat side to side as a signal to following traffic and to make passing even more difficult. This placement and maneuvering may take place much the same in embodiments that have traffic control vehicles driven by agents, or traffic control vehicles that are unmanned and automated.

In an alternative embodiment there may be two traffic control vehicles weaving over the three lanes or one weaving more widely to cover the three lanes. The speed of vehicles 301 together with the shape and width of the path results in a forward progression of the vehicles along highway 201 equal to V1, which is a speed determined to be correct to alleviate the congestion determined to be occurring at the region of the highway between cloverleaf 203c and 203b up ahead, without causing further congestion.

During the time of deployment of control vehicles SW 102 (FIG. 1) continues to determine state of congestion at the region between cloverleaf 203c and 203b. When it is determined that the congestion at the region between cloverleaf 203c and 203b has lessened to an extent that control is no longer needed, control vehicle 301 may be recalled. This may also occur if the control vehicle in its deployment approaches cloverleaf 203b.

When it is determined that control is no longer needed SW 102 signals processor 404 at station 203a that the vehicle(s) may be recalled. Processor 404 signals the control vehicles to return to the deploying station 203a, in the circumstance that automatic traffic control vehicles are used, or the driving agents may be instructed via their smartphones to disperse. The traffic control vehicles abandon the slow progression or the looping progression and move out of the way of following traffic.

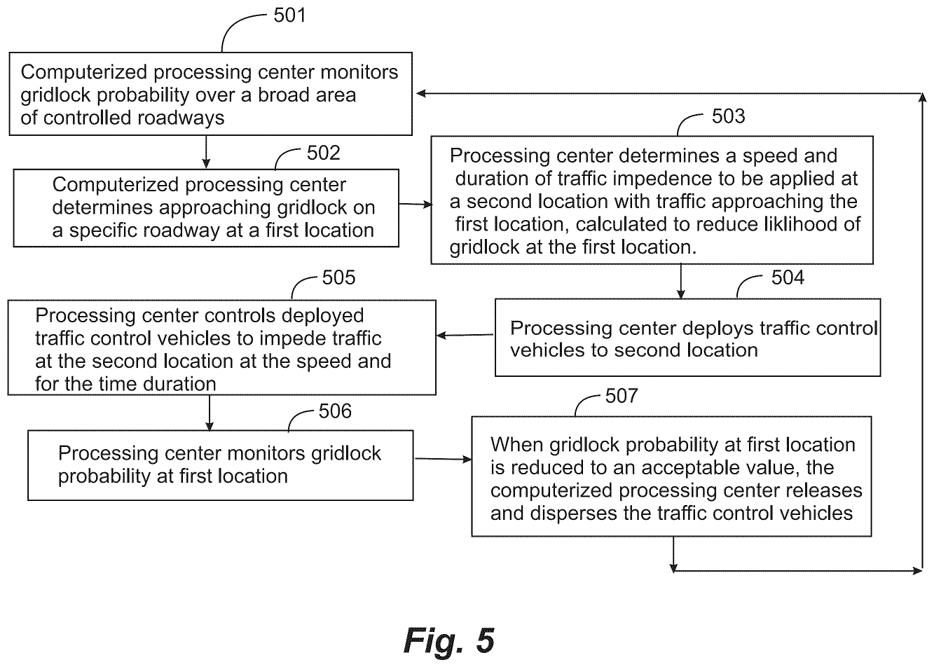

FIG. 5 is a flow diagram depicting a process in an example of the invention. At step 501 a computerized processing center monitors gridlock probability over a broad area of controlled roadways. At step 502 the computerized processing center determines approaching gridlock on a specific roadway at a first location in the controlled roadways. At step 503 the processing center determines a speed and duration of traffic impedance to be applied at a second location with traffic approaching the first location, calculated to reduce the likelihood of gridlock at the first location. At step 504 the processing center deploys traffic control vehicles to the second location. There may be traffic control vehicles already circulating on the controlled roadways near the second location.

At step 505 the processing center controls the deployed traffic control vehicles to impede traffic at the second location at the determined speed and for the time duration determined. At step 506 the processing center monitors gridlock probability at the first location, and at step 507, when gridlock probability at the first location us reduced to an acceptable value, the processing center releases and disperses the traffic control vehicles.

During the implementation of the several steps in the process particular to a specific first and a second location, the computerized processing center continues to implement step 501, monitoring gridlock probability over a broad area of controlled roadways. Traffic control vehicles may thusly be deployed to a plurality of locations simultaneously, and traffic controlled at the plurality of locations.

The skilled person will understand that the embodiments illustrated and described are entirely exemplary and are not limiting to the scope of the invention. The scope of the invention is limited only by the claims.

1. A traffic control system, comprising:
a roadway;
a computerized processing center scraping data from on-line traffic monitoring and reporting sites; and
a plurality of traffic control vehicles;
characterized in that the computerized processing center determines an increasing likelihood of gridlock at a specific location on the roadway, determines a speed and duration of traffic control to be applied at a second location with traffic approaching the first location, the speed and duration calculated to reduce the likelihood of congestion at the first location, and deploys individual ones of the plurality of traffic control vehicles to the second location and controls the individual ones of the traffic control vehicles to impede traffic at the second location to the determined speed for the determined duration.

2. The traffic control system of claim 1 further comprising sensing apparatus monitoring traffic conditions on the roadway, wherein the computerized processing center receives data from the sensing apparatus and utilizes that data in determining likelihood of congestion.

3. The traffic control system of claim 1 wherein the on-line traffic monitoring and reporting sites comprise one or more of Google Maps™, Waze™, Mapquest™.

4. The traffic control system of claim 2 wherein the computerized processing center builds models comprising characteristics of one or more of morning and evening congestion, frequent traffic accident areas, choke points and bottlenecks, emergency vehicle calls, road construction, lane maintenance routes and times and special and frequent events around large venues like stadiums, specific to a set of roadways.

5. The traffic control system of claim 1 wherein authorized knowledge workers access interactive interfaces presented by the computerized processing center, and through links and input fields in the interfaces specify specific roadways to be controlled, and for which data may be retrieved, processed, and utilized, constraining functionality to the specific roadways.

6. The traffic control system of claim 5 wherein the computerized processing center, utilizing algorithms especially developed for the purpose, builds a running circumstantial map of bottlenecks and potential bottlenecks on the specific roadway.

7. The traffic control system of claim 1 wherein the plurality of traffic control vehicles comprises automatically controlled vehicles deployed from stations along the roadway, the stations having computerized apparatus for receiving instructions from the computerized processing center and wireless communication apparatus adapted to deploy and control the plurality of traffic control vehicles in maneuvers to impede traffic flow.

8. The traffic control system of claim 1 wherein the plurality of traffic control vehicles comprises vehicles driven by agents of the system, the agents each having a smartphone executing a mobile app whereby the computerized processing center instructs the agents via the mobile app in maneuvering to impede traffic in traffic control operations.

9. The traffic control system of claim 1 wherein the individual ones of the traffic control vehicles are caused to maneuver at the second location in a manner to block following traffic for the determined duration from exceeding the determined speed.

10. The traffic control system of claim 9, wherein, at the end of the determined duration, the computerized processing center manages the deployed traffic control vehicles to disperse.

11. A traffic control method, comprising:
determining an increasing likelihood of gridlock at a specific location on a controlled roadway by a computerized processing center scraping data from on-line traffic monitoring and reporting sites;
determining a speed and duration of traffic control to be applied at a second location with traffic approaching the first location, the speed and duration calculated to reduce the likelihood of congestion at the first location; and
deploying individual ones of a plurality of traffic control vehicles to the second location and controlling the individual ones of the traffic control vehicles to block traffic at the second location to the calculated speed for the calculated duration.

12. The traffic control method of claim 11 further comprising sensing apparatus monitoring traffic conditions on the roadway, comprising the computerized processing center receiving data from the sensing apparatus and utilizing that data in determining likelihood of congestion.

13. The traffic control method of claim 11 comprising scraping data from on-line traffic monitoring and reporting sites comprising one or more of Google Maps™, Waze™, Mapquest™.

14. The traffic control method of claim 12 comprising the computerized processing center building models of one or more of morning and evening congestion, frequent traffic accident areas, choke points and bottlenecks, emergency vehicle calls, road construction, lane maintenance routes and times and special and frequent events around large venues like stadiums, specific to a set of roadways.

15. The traffic control method of claim 11 comprising authorized knowledge workers accessing interactive interfaces presented by the computerized processing center, and through links and input fields in the interfaces specifying specific roadways to be controlled, and for which data may be retrieved, processed, and utilized, constraining functionality to the specific roadways.

16. The traffic control method of claim 15 comprising the computerized processing center, utilizing algorithms especially developed for the purpose, building a running circumstantial map of bottlenecks and potential bottlenecks on the specific roadway.

17. The traffic control method of claim 11 wherein the plurality of traffic control vehicles comprises automatically controlled vehicles deployed from stations along the roadway, the stations having computerized apparatus for receiving instructions from the computerized processing center and wireless communication apparatus adapted to deploy and control the plurality of traffic control vehicles in maneuvers to impede traffic flow, comprising the computerized processing center deploying individual ones of the automatically controlled traffic control vehicles.

18. The traffic control method of claim 11 wherein the plurality of traffic control vehicles comprises vehicles driven by agents of the system, the agents each having a smartphone executing a mobile app whereby the computerized processing center instructs the agents via the mobile app in maneuvering to impede traffic in traffic control operations, comprising the computerized processing center deploying individual ones of the vehicles driven by agents of the system.

19. The traffic control method of claim 11 comprising controlling the individual ones of the traffic control vehicles to maneuver at the second location in a manner to block following traffic for the determined duration from exceeding the determined speed.

20. The traffic control method of claim 19, comprising, at the end of the determined duration, the computerized processing center managing the deployed traffic control vehicles to disperse.
